(19) United States
(12) Patent Application Publication
(10) Pub. No.: US 2012/0124561 A1
(43) Pub. Date: May 17, 2012

(54) Obtaining Notes for Software Objects

(75) Inventor: Carlos Martinez Escribano, Madrid (ES)

(73) Assignee: SAP AG, Walldorf (DE)

(21) Appl. No.: 12/948,406

(22) Filed: Nov. 17, 2010

(51) Int. Cl. G06F 9/44

(52) U.S. Cl. 717/128

(57) ABSTRACT

A computer-implemented method for obtaining notes for software objects includes: reproducing, in a customer computer system, a problem that has been detected in the customer computer system; performing a trace while reproducing the problem, the trace identifying at least one object in the customer computer system as being involved in reproducing the problem; identifying, from among multiple notes in a notes repository, at least a first note as applying to the identified object, the identified first note configured for implementation in the customer computer system; and presenting the identified first note in the customer computer system.

### TECHNICAL FIELD

This document relates to obtaining notes for software objects.

### BACKGROUND

Enterprise software can manage, record, and facilitate transactions in an enterprise system. Components of enterprise software can be distributed across hardware devices and/or virtual environments, as well as across geographic locations. Some enterprise software is designed for reuse, and contains components that are designed to meet general business needs. For example, enterprise resources planning (ERP) systems perform a multitude of functions within an organization. One or more components in an ERP system can gather, generate, process, and store transactional information. For example, sales documentation, customer files and accounting records of an organization are handled at least in part by one or more applications. Other components, in contrast, can be designed for analytical functions, such as for generating reports.

### SUMMARY

The invention relates to obtaining notes for software objects.

In examples described herein, a customer or other system user is aided in seeking a solution to a problem observed in the system. First, the user reproduces the problem in a development system, as opposed to, say, a production system that the customer uses in its business operations and in which the problem was observed. While the problem is being reproduced, a software trace (e.g., a listing of a computer program's execution steps performed by the process of tracing) is performed on each step of the reproduction. Programs, subprograms, functions or any other objects that are involved in any of the traced steps are identified. This list of identified objects can be presented to the user, classified by the application or area they relate to, such as Payroll, Finance, Material management, to name a few examples. The user can focus the search by selecting one or more of the applications or areas (or objects for a more restricted search). The support pack status of the customer's system is determined, including any additional note(s) that may have been installed since the most recent support pack. A search for notes associated with the identified (and selected) objects is then performed. If an application component is chosen, the note search will be done for all the objects that belong to the application component(s) selected for the note search. Notes belonging to support packs that the customer has installed, or other notes that the customer has implemented, are ignored in the search. The user is presented with the resulting note(s) found in the search, and can review the description, and/or choose to implement, any or all of the notes.

While reproducing the problem in a test system was mentioned as an example above, the tool or other implementation that seeks the solution can work similarly or identically in the test system as in the production system.

In a first aspect, a computer-implemented method for obtaining notes for software objects includes: reproducing, in a customer computer system, a problem that has been detected in the customer computer system; performing a trace while reproducing the problem, the trace identifying at least one object in the customer computer system as being involved in reproducing the problem; and determining, using the computer system, whether any of multiple notes configured for implementation in the customer computer system apply to the identified object.

In a second aspect, a computer program product tangibly embodied in a computer-readable storage medium includes instructions that when executed by a processor perform a method for obtaining notes for software objects. The method includes: reproducing, in a customer computer system, a problem that has been detected in the customer computer system; performing a trace while reproducing the problem, the trace identifying at least one object in the customer computer system as being involved in reproducing the problem; and determining, using the computer system, whether any of multiple notes configured for implementation in the customer computer system apply to the identified object.

In a third aspect, a system includes: at least one processor; and a computer readable medium including instructions that when executed by the processor generate operations comprising: reproducing, in a customer computer system, a problem that has been detected in the customer computer system; performing a trace while reproducing the problem, the trace identifying at least one object in the customer computer system as being involved in reproducing the problem; and determining, using the computer system, whether any of multiple notes configured for implementation in the customer computer system apply to the identified object.

Implementations can include any or all of the following features. The problem is detected in a production system in the customer computer system, wherein the customer computer system further includes a development system from which the production system was generated, and wherein the problem is reproduced in the development system. At least one first note is identified as applying to the identified object, and the method further includes presenting the at least one first note in the customer computer system. The method further includes: determining a support pack level for the customer computer system; and determining a support pack level association for the at least one first note; ignoring the at least one first note if the support pack level association is at most equal to the support pack level. The method further includes: identifying at least one second note implemented in the customer computer system that is not reflected by the support pack level; and ignoring also the identified at least one second note. The method further includes checking that the notes are valid for a current release. The method further includes: determining that at least one customer extension implemented in the customer computer system is involved in reproducing the problem; and identifying the customer extension to a user. Determining that the customer extension is involved comprises: accessing a customization record that indicates customer-modified objects; and determining whether the customization record indicates the at least one object identified in the trace.

The details of one or more implementations are set forth in the accompanying drawings and the description below. Other features and advantages will be apparent from the description and drawings, and from the claims.

### DESCRIPTION OF DRAWINGS

FIG. 1 shows a process that can be performed to obtain notes for software objects.

FIG. 2 shows a system that can be used to obtain notes for software objects.

FIG. 3 shows application components identified in a trace.

FIG. 4 shows identified notes.

FIG. 5 shows an example of a note.

FIG. 6 is a block diagram of a computing system that can be used in connection with computer-implemented methods described in this document.

Like reference symbols in the various drawings indicate like elements.

### DETAILED DESCRIPTION

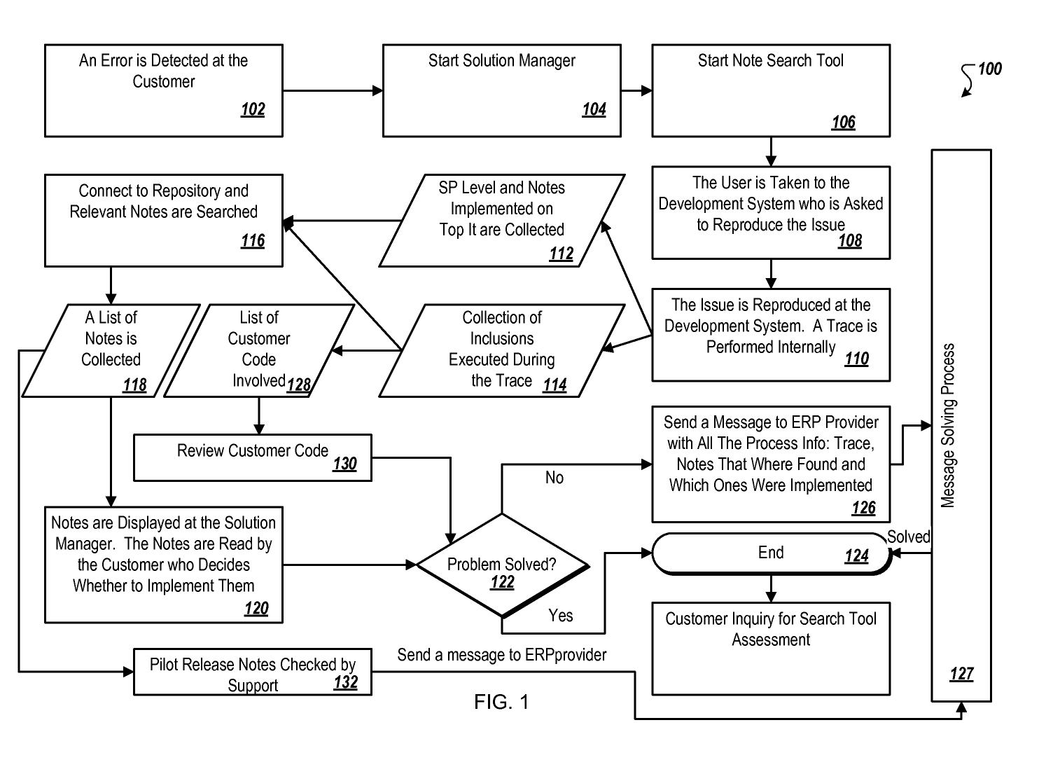

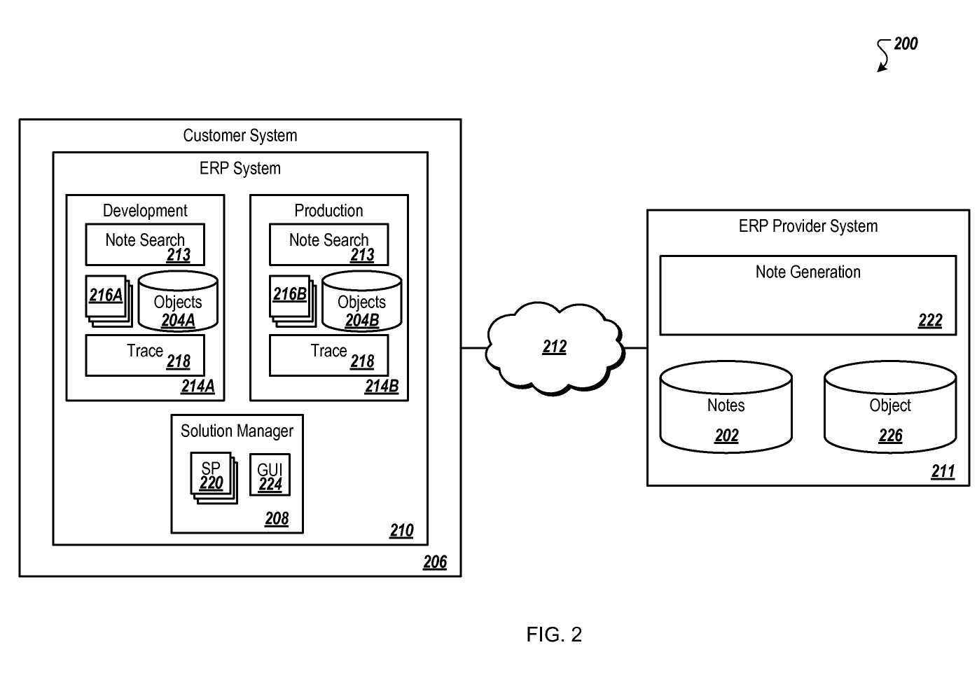

FIG. 1 shows a process 100 that can be performed to obtain notes for software objects. In some implementations, a customer that identifies a problem in an implemented system can use the process 100 to obtain notes relevant to the problem, and implement one or more of the notes to seek a solution to the problem. For example, such notes are correction updates directed at single problems, as opposed to support packages that are released periodically and contain all the corrections to that were released in that period. FIG. 2 shows a system 200 that can be used to obtain notes 202 for software objects 204A-B. For illustration purposes, reference will be made to some components of the system 200 in describing some examples regarding the process 100.

At 102, an error or other problem is detected at a customer. In some implementations, a customer system 206 is a computer system operated by a customer, which can be an organization, a corporation, an agency, or an individual, to name just a few examples. For example, the customer system 206 is an ERP system, at least in part.

Any kind of problem can be detected. First, the problem can involve malfunction of the computer system 206. For example, the problem can be observed when the system does not perform an action that it should or is expected to perform, or when the system performs an action that it should not, or is not expected to, perform under current circumstances.

Second, the problem can involve data corruption or other inconsistencies. For example, the problem can be observed when the system generates the wrong type of data, or when the system generates data having the wrong value(s). In this particular example, the observed problem is that the customer system specifies an income tax rate of ten percent, where the correct value which was expected is only nine percent. Combinations of the above types of problems can be detected. More than one problem can be detected.

At 104, the customer or an administrator of the customer's system starts a solution manager to investigate the problem. In some implementations, a solution manager 208 is implemented in the customer system 206. For example, some or all of the components in the customer system 206 are obtained from an ERP provider, and the solution manager 208 is delivered to the customer by the ERP provider for use in installing, implementing, and running ERP solutions from the provider. The customer system 206 includes an ERP system 210 created by the ERP provider. For example, the ERP system 210 was developed and created by the ERP provider using an ERP provider system 211. The ERP provider system 211 and the customer system 206 are connected to each other (and optionally to other systems or devices) through any suitable kind of computer network 212, for example including a local area network or the internet.

At 106, the customer starts a tool for searching notes. For example, a note search tool 213 is included in a development system 214A, or in a production system 214B, or in both. In some implementations, the note search tool 213 started from the solution manager 208, which is connected to the systems 214A-B. In implementations where the solution manager 208 is not implemented or not used, the system can proceed from detecting an error (at 102) to starting the tool (at 106), and the note search tool 213 then works in a standalone mode.

At 108, the customer is taken to a development system for reproducing the problem. In some implementations, the customer system 206 includes the development system 214A and the production system 214B. For example, the development system 214A was obtained from the ERP provider, and was used to develop and implement the production system 214B that the customer is using in its business endeavors. Either or both of the systems 214A-B can be implemented using one or more hardware devices, such as server computers. In some implementations, a third system called a “test” system is also used. For example, the note search tool 213 can be implemented in any or all of the systems 214A-B and the test system.

The development and production systems can contain executable code for running one or more applications. For example, an ERP application such as a customer relationship management (CRM) application can be implemented. As another example, a payroll application can be implemented. The applications 216A-B are configured to use the respective objects 204A-B in operation. For example, the objects 204A-B can include data for the application(s), such as customer records for the CRM application or employee data for the payroll application.

Accordingly, the development system 214A is launched at 108 unless it is running already. In some implementations, the user can specify in 108 one or more of the applications 216B that was being executed at the time and the corresponding application(s) can then be initiated in the development system. For example, the note search tool 213 can generate a screen where the user can identify or otherwise select one or more transactions, such as a transaction for maintaining master data records for employees. In some implementations, the development system is launched with the right component(s) active in response to the user specifying the transaction(s) of interest.

In this example, the problem detected while running the production system 214B was that the income tax deduction has the wrong value. Accordingly, the process 100 seeks to reproduce that problem in the development system. That is, in this example, the user is taken to the screen or view that displays the percentage level for the income tax deduction.

At 110, the problem is reproduced. For example, the screen presented to the user shows the wrong percentage value, as did the production system earlier. In reproducing the problem, a trace is performed. In some implementations, the customer system 206 includes a trace component 218 that allows the user to go step-by-step through the whole process, or part thereof, while tracing the object(s) involved in doing so. The trace component 218 is included in the system where the problem is detected or reproduced, such as in the development system 214A, or in the production system 214B, or in both. For example, the user can be guided through the steps of entering employee master data according to some or all of the following categories:

### Employee Master Data

Personnel number
Name
Employee group
Personnel area
Employee subgroup
Start and end dates
ID number
Work permit number
Country
Expatriation situation
Foreign code
Province
Employee or employer tax modifier
Payment key
Marital status
Personal situation
Challenge category
Enter reduction due to geographic mobility end date
Mortgage
Gross salary
Fixed variables
Varying variables
Payment in kind
Reduction due to irregular performance
Social Security contribution
Other reductions
Compensation payments
Child maintenance
Settlement basis
Family members
Decrease in income tax contribution due to mortgage

That is, in this example the user can enter the values or other information for any or all of the above categories of employee master data, and this can be done in a step-by-step fashion (e.g., through a form or wizard) while the system traces the involved objects.

Based on the employee master data, and optionally also on other available information, the system can calculate or otherwise determine one or more characteristics about the employee, such as the income tax deduction percentage in this example. In some implementations, a separate screen, or area of a screen, is used to present employment tax deduction information to the user regarding a particular employee. For example, any or all of the following information categories can be presented:

### Employment tax deduction information

Calculated percentage
Percentage applied
Payroll percentage
Reason for markdown
Contract arrangement
Previous percentage
Deductions
Gross income received
Reason for adjustment

Here, any of the three first listed categories may show an unexpected or incorrect percentage number, for example ten percent instead of nine. In other words, the problem of the inaccurate tax percentage has been reproduced in the step-by-step process.

At 112, a support pack level for the customer computer system is determined. In some implementations, the customer system 206 has stored one or more support pack records 220 corresponding to support packs that have previously been received from the ERP provider system 211. Each of the support pack records 220 implements one or more of the notes 202. That is, each of the notes 202 can be associated with a corresponding support pack.

The following generally describes how the notes 202 can be created. In some implementations, the ERP provider system 211 includes a note generation tool 222, such as a module for writing software code and creating accompanying documentation. For example, when the ERP provider determines that any of its solutions, such as one of the applications 216A-B has a bug or other defect, or otherwise needs to be improved, the ERP provider instructs its developer(s) to create the necessary update in form of a note for implementation on any system running the ERP provider's solution(s). The note includes the necessary object update(s) and also written instructions explaining what the note does, how to implement the note, and whether the customer should make any other change(s), for example.

When received at the customer system 206, the note is implemented, for example by execution of a transaction or other procedure. The notes 202 can be delivered to the customer in form of support packs at regular intervals, or in form of ad-hoc support packs as needed. For example, if a customer has an urgent problem that requires a note, the ERP provider can forward a support pack with the note to the customer directly after the note is created, rather than slating the note to be included in the next available scheduled support pack to that customer. Such notes that have been implemented in the customer system as advance corrections are also identified when the support pack level is determined. In some implementations, all “standard” notes will sooner or later be included in a support package, and if the matter is not urgent, a customer can wait until such support package is delivered and not implement any note in advance. Some notes are forwarded as pilot releases only to selected customers, as will be described in a later example.

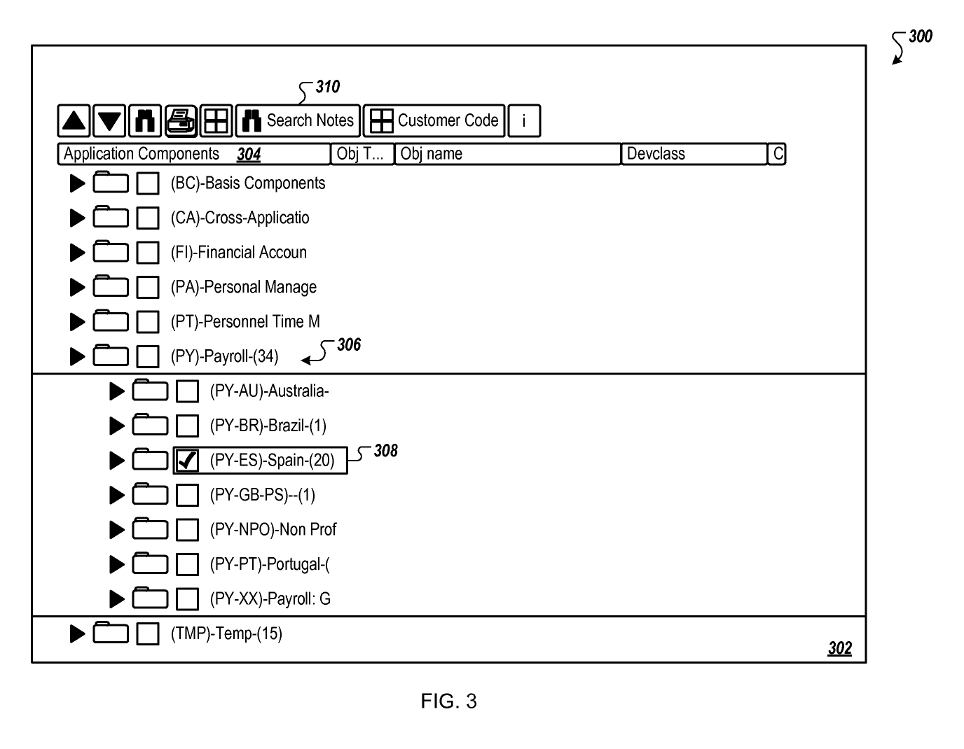

Because the involved objects are traced during the error reproduction, a collection of relevant objects can be generated. At 114, the “inclusions” executed during the trace are collected, meaning any form of information or code involved in reproducing the problem. FIG. 3 shows application components 300 identified in a trace. In some implementations, the application components 300 are presented to the user in a display 302, such as in a graphical user interface 224 of the solution manager 208 or of the customer system 206. For example, the components can be listed in a components column 304. Here, a number of components are shown as examples, including “Financial Accoun[ts],” “Personnel Manage[ment]” and a “Payroll” component 306.

Each component or application can include one or more subcomponents or other objects. Such subcomponents are included among the application components 300 if the subcomponents were identified in the trace, otherwise not. Here, the Payroll component 306 includes a number of payroll objects representing payroll information in various geographic areas, including an object 308 representing payroll information for Spain.

At 116, the user initiates a search for relevant notes. That is, the notes associated with one or more application components or single objects identified in the trace are to be identified. The note search tool 213 provides the necessary search function. In this example, the problem with the incorrect tax percentage has been observed only for one geographical region (Spain), and the user therefore selects the object 308. Then, the user activates the search for notes using a control 310.

All the notes associated with a relevant object are not necessarily relevant to the particular user. For example, notes that have already been implemented in the customer system should not be installed again, absent special circumstances. Such notes can therefore be ignored in the search. That is, notes that are included in the customer's existing support pack(s), or in any additional installed support pack(s), are not presented as possible solutions to the customer's problem. In some implementations, a check is performed that the note or notes are valid for a current release that is installed in the customer's system. For example, some notes are release dependent.

Rather, at 118, a list of relevant notes is collected. For example, the search is performed among the notes 202 in the ERP provider system 211.

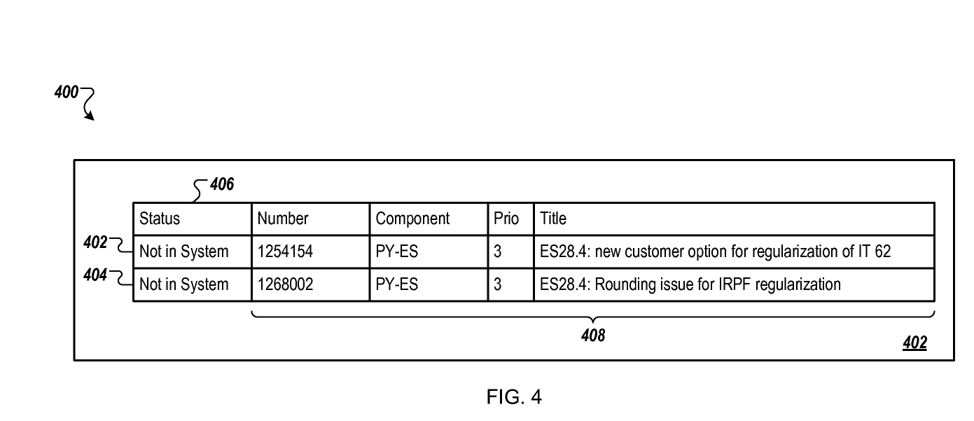

At 120, the identified notes are presented to the customer. FIG. 4 shows identified notes 400. In some implementations, the identified notes 400 are presented to the user in a display 402, such as in the graphical user interface 224 of the solution manager 208 or of the customer system 206. Here, the identified notes 400 include a note 402 and a note 404. The display 402 includes a status column 406 showing the status of presented notes, such as “Not in system” for the notes 402 and 404.

In situations where only the already installed notes are presented in the search results, this status will be indicated in accordingly in the column 406. In other situations, by contrast, notes that have been completely implemented are simply not displayed.

Information about each note is shown in information columns 408, such as the note's number, the component with which the note is associated, and the note title. The user can select either or both of the notes 402 and 404 to see more information, or to implement the note.

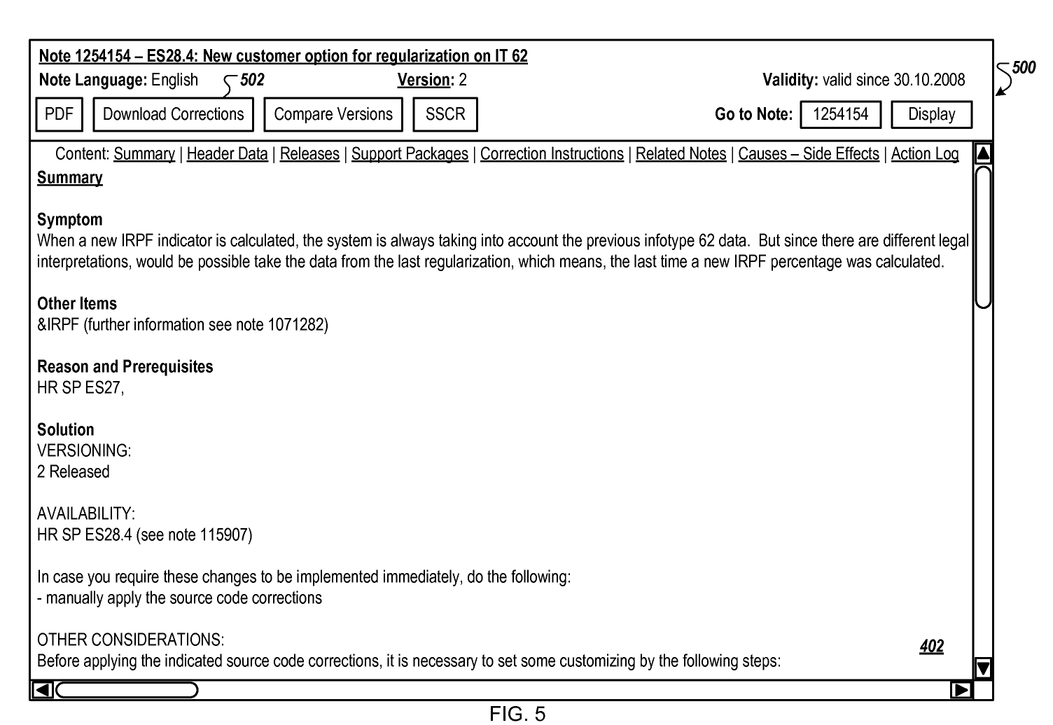

Here, the user selects the note 402. FIG. 5 shows the note 402. In this example, the note 402 is configured for use with an SAP system. The note 402 includes information 500 describing the note, how it is used, and its status. The user can initiate implementation with a control 502. For example, this triggers a transaction to download the entire note from the ERP provider system 211 and implement the revision(s) of the note. The system also updates records to show that the selected note has been implemented, so that this information is known in subsequent note searches. More than one note can be implemented.

At 122, the process 100 determines whether the problem has been solved. For example, if implementing the note(s) solved the problem, then the answer is “Yes” and process 100 ends at 124. If the problem has not been solved, then a message is sent to the ERP provider at 126. Relevant information is included in the message. In some implementations, the message identifies the trace results, the found note(s) and the implemented note(s), if any. A message solving process is performed by the ERP provider at 127. For example, the ERP provider uses the received message information in the note generation tool 222 to develop another note to solve the problem. When the problem is resolved, the process 100 ends at 124.

If a customer-specific code was involved in reproducing the problem, the problem is not necessarily caused by the ERP provider's software. At 128, the process 100 determines what customer code, if any, is involved in reproducing the problem. In some implementations, the ERP provider system 211 includes an object record 226 that reflects whether any of the applications 216A-B or the objects 204A-B have been customized. Such information can be forwarded to the ERP provider system 211 by the development system 214A.

Customer modifications are not always reflected in the object record 226. In some implementations, changes in standard objects are detected, but for fr other changes it is considered normal procedure that the customer inserts its own code without first obtaining a key from the ERP provider system 211. Examples of such enhancement points include, but are not limited to, business add-ins (Badis), user exits and field exits.

Accordingly, the information about such modification is not available in the ERP provider system 211 but rather is stored in the development system 214A and the production system 214B.

That is, based on knowing the object(s) involved in reproducing the problem, and what object(s), if any, the customer has modified in its system, a list of the customer extensions or other customized code is generated at 128. At 130, the customer code is reviewed. For example, the note search tool 213 presents the list of relevant customer code in the GUI 224 and prompts the customer to review the code for possible revision or removal. After review, the process continues at 122 as above.

Some of the notes 202 are included in pilot releases to only one or more selected customers. At 132, pilot release notes that were found in the search are checked by technical support staff of the ERP provider. For example, a message is sent to alert the ERP provider of the possible use of the pilot release note(s). This initiates the message solving process 127.

At 134, an inquiry is sent to the customer. In some implementations, the inquiry relates to assessment of the note search tool 213. For example, the customer is prompted to review the search tool or make recommendations for improving the tool or a note, such as to improve the description of the problem in the information 500.

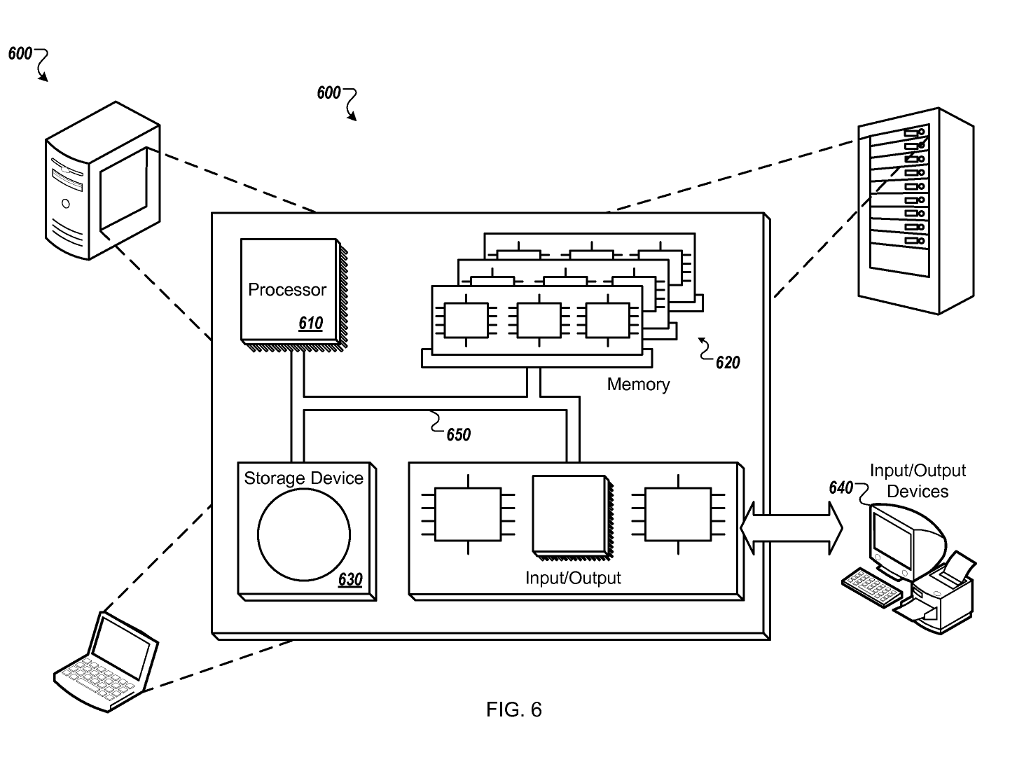

FIG. 6 is a schematic diagram of a generic computer system 600. The system 600 can be used for the operations described in association with any of the computer-implemented methods described previously, according to one implementation. The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. The memory 620 is a volatile memory unit in some implementations and is a non-volatile memory unit in other implementations.

The storage device 630 is capable of providing mass storage for the system 600. In one implementation, the storage device 630 is a computer-readable medium. In various different implementations, the storage device 630 may be a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made without departing from the spirit and scope of this disclosure. Accordingly, other implementations are within the scope of the following claims.

What is claimed is:

1. A computer-implemented method for obtaining notes for software objects, the method comprising:
reproducing, in a customer computer system, a problem that has been detected in the customer computer system;
performing a trace while reproducing the problem, the trace identifying at least one object in the customer computer system as being involved in reproducing the problem; and
determining, using the computer system, whether any of multiple notes configured for implementation in the customer computer system apply to the identified object.

2. The computer-implemented method of claim 1, wherein the problem is detected in a production system in the customer computer system, wherein the customer computer system further includes a development system from which the production system was generated, and wherein the problem is reproduced in the development system.

3. The computer-implemented method of claim 1, wherein at least one first note is identified as applying to the identified object, further comprising presenting the at least one first note in the customer computer system.

4. The computer-implemented method of claim 3, further comprising:
determining a support pack level for the customer computer system;
determining a support pack level association for the at least one first note; and
ignoring the at least one first note if the support pack level association is at most equal to the support pack level.

5. The computer-implemented method of claim 3, further comprising:
identifying at least one second note implemented in the customer computer system that is not reflected by the support pack level; and
ignoring also the identified at least one second note.

6. The computer-implemented method of claim 3, further comprising checking that the at least one first note is valid for a current release.

7. The computer-implemented method of claim 1, further comprising:
determining that at least one customer extension implemented in the customer computer system is involved in reproducing the problem; and
identifying the customer extension to a user.

8. The computer-implemented method of claim 7, wherein determining that the customer extension is involved comprises:
accessing a customization record that indicates customer-modified objects; and
determining whether the customization record indicates the at least one object identified in the trace.

9. A computer program product tangibly embodied in a computer-readable storage medium and comprising instructions that when executed by a processor perform a method for obtaining notes for software objects, the method comprising:
reproducing, in a customer computer system, a problem that has been detected in the customer computer system;
performing a trace while reproducing the problem, the trace identifying at least one object in the customer computer system as being involved in reproducing the problem; and
determining, using the computer system, whether any of multiple notes configured for implementation in the customer computer system apply to the identified object.

10. The computer program product of claim 9, wherein the problem is detected in a production system in the customer computer system, wherein the customer computer system further includes a development system from which the production system was generated, and wherein the problem is reproduced in the development system.

11. The computer program product of claim 9, further comprising:
determining a support pack level for the customer computer system; and
determining a support pack level association for each of the multiple notes identified as applying to the identified object;
ignoring any of the multiple notes for which the support pack level association is at most equal to the support pack level.

12. The computer program product of claim 11, further comprising:
identifying at least one second note implemented in the customer computer system that is not reflected by the support pack level; and
ignoring also the identified at least one second note.

13. The computer program product of claim 9, further comprising:
determining that at least one customer extension implemented in the customer computer system is involved in reproducing the problem; and
identifying the customer extension to a user.

14. The computer program product of claim 13, wherein determining that the customer extension is involved comprises:
accessing a customization record that indicates customer-modified objects; and
determining whether the customization record indicates the at least one object identified in the trace.

15. A system comprising:
at least one processor; and
a computer readable medium including instructions that when executed by the processor generate operations comprising:
reproducing, in a customer computer system, a problem that has been detected in the customer computer system;
performing a trace while reproducing the problem, the trace identifying at least one object in the customer computer system as being involved in reproducing the problem; and
determining, using the computer system, whether any of multiple notes configured for implementation in the customer computer system apply to the identified object

16. The system of claim 15, wherein the problem is detected in a production system in the customer computer system, wherein the customer computer system further includes a development system from which the production system was generated, and wherein the problem is reproduced in the development system.

17. The system of claim 15, further comprising:
determining a support pack level for the customer computer system; and
determining a support pack level association for each of the multiple notes identified as applying to the identified object;
ignoring any of the multiple notes for which the support pack level association is at most equal to the support pack level.

18. The system of claim 17, further comprising:
identifying at least one second note implemented in the customer computer system that is not reflected by the support pack level; and
ignoring also the identified at least one second note.

19. The system of claim 15, further comprising:
determining that at least one customer extension implemented in the customer computer system is involved in reproducing the problem; and
identifying the customer extension to a user.

20. The system of claim 15, wherein determining that the customer extension is involved comprises:
accessing a customization record that indicates customer-modified objects; and
determining whether the customization record indicates the at least one object identified in the trace.
